(19) United States
(12) Patent Application Publication
(10) Pub. No.: US 2020/0250686 A1
(43) Pub. Date: Aug. 6, 2020

(54) COMMUNICATION APPARATUS AND METHOD

(71) Applicant: JAB S.R.L., BOLOGNA (IT)

(72) Inventor: Jessica ABBUONANDI, BOLOGNA (IT)

(21) Appl. No.: 16/635,045

(22) PCT Filed: Jul. 31, 2018
(86) PCT No.: PCT/IB2018/055732

§ 371 Date: Jan. 29, 2020

(30) Foreign Application Priority Data
Aug. 2, 2017 (IT) 102017000089190

(51) Int. Cl. G06Q 30/00; G06Q 30/02

(52) U.S. Cl. CPC G06Q 30/0185; G06Q 30/0273; G06Q 30/0281

(57) ABSTRACT

A method for communicating intellectual contents comprises the following steps: preparing a remote server and a client device including a screen, an input device and a control unit; executing a registration module and collecting registration data; transmitting registration data to a remote server and saving the registration data to the remote server; executing an access module and collecting access data; authenticating; executing an advertising module and collecting multimedia contents; transmitting multimedia contents to a remote server and saving multimedia contents to the remote server executing a notice board module and loading multimedia contents to the notice board module; the method is characterized in that in the step of executing the registration module, the control unit compulsorily collects the acceptance of a confidentiality (non-disclosure) agreement of the search user and in that the step of executing the advertising module comprises a step of generating a history of the multimedia contents.

### TECHNICAL FIELD

This invention relates to an apparatus for communicating intellectual contents and a method for communicating intellectual contents.

### BACKGROUND ART

Known in the technical sector which this disclosure addresses are apparatuses for sharing intellectual contents. These apparatuses comprise a plurality of client devices through which users can view the intellectual contents. An apparatus for communicating intellectual contents also comprises a remote server, connected to the Internet, where the intellectual contents will be saved. Thus, a user may, on the one hand, share intellectual contents by saving them to the remote server and allowing them to be downloaded to other client devices, and on the other, view the intellectual contents shared by other users operating on other client devices. Owing to the importance and uniqueness of certain intellectual contents, the problem arises as to how a user who possesses a commercially attractive intellectual content can share it to arouse the interest of potential buyers without losing the confidentiality of what has been shared or allowing the intellectual content to be used by others without due compensation. In other words, current apparatuses for the communication of intellectual contents do not allow the intellectual contents to be shared without this constituting public disclosure and above all they do not guarantee the possessor of the intellectual content an economic right to use that intellectual content. Moreover, in order to protect and demonstrate the intellectual property of a content, it is essential to keep a record of the time when a multimedia content is shared Current systems for communicating multimedia contents do not provide a certified date of posting the multimedia content and are therefore liable to confusion regarding the property of each intellectual content.

### AIM OF THE INVENTION

This disclosure has for an aim to provide a method and an apparatus for communicating intellectual contents to overcome the abovementioned drawbacks of the prior art.

More specifically, the aim of this disclosure is to provide a method and an apparatus for communicating intellectual contents that overcome the above mentioned drawbacks.

This aim is fully achieved by the method and apparatus of this disclosure, for communicating intellectual contents, as characterized in the appended claims.

In one embodiment, the method for communicating intellectual contents comprises a step of preparing a client device. In one embodiment, the method comprises a step of preparing a remote server. By client device is meant a computer device capable of processing digital contents: for example, but not limited to, a computer, a tablet, a smartphone or the like.

In one embodiment, the client device includes a screen. In one embodiment, the client device includes an input device. By input device is meant any tool which makes it possible to interact with the client device to control the operation thereof: for example, but not limited to, a printer, a mouse, a trackpad or a joystick. In one embodiment, the client device includes a control unit.

In one embodiment, the intellectual contents are a representation of work, projects, or products susceptible of protection in the intellectual property field (for example, according to copyright or according to regulations pertaining to secret information, patents, designs or models, trademarks, depending on the nature of the intellectual contents).

In one embodiment, the intellectual contents are a representation of work, projects, or products of an innovative nature in technical or aesthetic terms.

In one embodiment, the intellectual contents are legal titles of industrial property.

In one embodiment, the industrial property titles are patents. Each patent describes an invention susceptible of industrial application by means of a written text and a plurality of drawings to support the text.

In one embodiment, the industrial property titles are industrial designs. Each industrial design is described by a plurality of drawings which illustrate all the possible views of the specific design.

In one embodiment, the industrial property titles are trademarks. Each trademark describes the features of a trademark, that is to say, a recognizable sign (which may be denominative, figurative or of any other kind).

In one embodiment, the intellectual contents are inventions, designs or trademarks which are not yet titled as such but which can potentially be made the subject of an application for obtaining a future legal title of industrial property. In this embodiment, the intellectual content may be expressed by a representation of a prototype, a technical report, schematic or construction drawings or any other description or representation of the solution.

In one embodiment, the intellectual contents are business plans. In this embodiment, the advertising user may describe the intellectual content with text documents, such as planning and programming projects, and, if necessary, project-related business models and market survey reports.

In one embodiment, the intellectual contents are works of creativity with artistic value.

In one embodiment, the intellectual contents are economic proposals or transactions such as, for example but not limited to, business merger proposals, requests for joint ventures or strategic cooperation.

In one embodiment, the method includes a step of putting digital signatures on one or more documents loaded on the platform. Thus, the platform is configured to put digital signatures on one or more documents.

In one embodiment, the method includes a step of putting a time stamp on one or more documents loaded on the platform or processed by it. Thus, the platform is configured to put signatures and time stamps on one or more documents.

In one embodiment, the method includes a step of subordinating the use of one or more contents of the platform to the signing of a confidentiality (non-disclosure) agreement, so that before accessing one or more platform contents, it is necessary to keep the contents that will be accessed confidential (under one or more clauses displayed by the platform on the client computer). Thus, the platform is configured to display information on the client computer from a remote location, thereby subjecting a user to a bond of confidentiality as a necessary condition to allow access to one or more platform contents. This provides an advertising user with a showcase to make their ideas, projects or innovations known without thereby disclosing that information (in the sense of divulging it to an indefinite number of people without any bond of confidentiality).

In particular, the confidentiality agreement allows to solve the drawback of the prior art solutions, in which to have a certain visibility of your own ideas you have to divulge the content to an indefinite number of people without any bond of confidentiality.

In one embodiment, the method also includes a step of preparing training courses through a remote link, for example through a video conference or Webinar.

In one embodiment, the method also includes a step of requesting a translation of documents through the platform and a step of generating and sending the requested translations by remote service.

In one embodiment, the platform is configured to establish protected links between platform users to exchange data, make voice calls or conduct video conferences.

In one embodiment, the platform provides links to one or more search engines to retrieve information with reference in particular (but not exclusively) to business data.

In one embodiment, the method comprises a step of executing a registration module through the control unit. The term “execute” will hereinafter be used to indicate the activity of the control unit to convert a computer code into an activity of the client device. The term “module”, on the other hand, is used to indicate a part of the apparatus which comprises specific graphics, logic and code lines corresponding to activities executed by the control unit on the other components of the apparatus for communicating intellectual contents. In one embodiment, the method comprises a step of collecting registration data of a search user. In one embodiment, the method comprises a step of collecting registration data of an advertising user. By “search user” is meant a user who uses the apparatus to search for intellectual contents advertised for use by other users. By “advertising user” is meant a user who uses the apparatus to advertise their intellectual contents in such a way that they can be viewed by other users interested in utilizing the intellectual contents.

In one embodiment, the method comprises a step of transmitting registration data. The registration data are private data which both the search user and the advertising user must provide the apparatus with before they can use the functions of the apparatus. In one embodiment, transmission is from the client device to a remote server through an Internet connection. In one embodiment, the method comprises a step of saving registration data to the remote server.

In one embodiment, before completing the step of registration, the search user or the advertising user displays one or more of the following information items:
a summary description of the possibilities that the apparatus provides for each type of client, including the description of the managers of the apparatus;
a promotional video;
a contact form;
an informative blog regarding the apparatus concerned.

In one embodiment, the method comprises a step of executing an access module through the control unit. In one embodiment, the method comprises a step of collecting access data of a search user or of an advertising user.

In one embodiment, the access data are at least partly the same as the registration data saved in the remote server.

In one embodiment, the method comprises a step of authenticating implemented through the control unit to check the matching between the registration data and the access data for the search user or the advertising user.

In one embodiment, the method comprises a step of executing an advertising module through the control unit. In one embodiment, the method comprises a step of collecting multimedia contents. By multimedia contents we mean any set of computer data which, when suitably converted by the control unit, can transmit information to the search user or advertising user as to the nature of a specific intellectual content such as, for example, but not limited to, photos, videos, audios or text files.

In one embodiment, the multimedia contents may be unique entry details, such as, for example, one or more of the following data items relating to the advertiser:
name;
surname;
username;
date of birth;
password;
personal image;
taxpayer details;
invoicing address;
contact details such as phone number, email address, web site;
bank details;
default language;
consent to receive notices or newsletters.

In one embodiment, the multimedia contents may be variable entry data, corresponding to a specific intellectual content, such as for example, one or more of those listed below:
pages;
articles;
products;
images;
videos;
text files;
general contents regarding the project, in the form of computer strings;
custom fields relating to economic or consultancy proposals.

In one embodiment, the method comprises a step of transmitting multimedia contents from the client device to a remote server through an Internet connection. In one embodiment, the method comprises a step of saving multimedia contents to the remote server.

In one embodiment, the method comprises a step of executing a notice board module through the control unit. In one embodiment, the method comprises a step of transmitting multimedia contents from the remote server to the client device through an Internet connection. In one embodiment, the method comprises a step of loading multimedia contents to the notice board module.

In one embodiment, the method comprises a step of creating a notice board. In the step of creating the notice board, all the tools that a user can use to share his intellectual contents are created.

In one embodiment, the method comprises a step of customization of the notice board. In the step of customization of the notice board, a user can modify the contents he has inserted in the notice board to update them. In the step of customization of the notice board, the notice board module allows you to edit the text of the notice board, to edit the summary of the intellectual content, to change the notice board name, to upload files or images, to edit the profile image, to edit the representative image in a title of the notice board module, to change the purpose for which the notice board is being used.

In one embodiment, the method comprises a step of sharing of the notice board module. In such step of sharing of the notice board module, a plurality of users can access the notice board module from remote computer devices to edit the contents thereof. This allows a working group to intervene on the contents of the notice board module from different geographical locations, thus facilitating cooperation between various users.

In one embodiment of the method, the following steps can be performed in the notice board module:
Generation of a standard sales contract between a registered user to whom the notice board is associated and a buyer interested in the content shown on the notice board or request for specific advice relating to contracts.
Generation and signing of a confidentiality (non-disclosure) agreement between a registered user to whom the notice board is associated and a buyer interested in the content shown on the notice board module or request for specific legal advice.
Request for a notary filing that further certifies the ownership of the specific intellectual content shown on the notice board module;
Consultation of regulations concerning intellectual property.

In one embodiment of the method, the method comprises a step of publication of a notice board module, wherein the apparatus makes visible the content of a specific notice board module associated with a user to all registered and authorized users.

In one embodiment, the method comprises a step of profile customization. In the step of profile customization, a user can modify data related to his personal profile, visible to other users who use the apparatus.

In one embodiment, the method comprises a step of product insertion in the notice board module. In this step, a user sends data of a product to the apparatus, which saves the product data in the remote server and retrieves them to show them on notice boards modules of other users interested in the sale. In one embodiment, the product data may include one or more of the following information:
Budget necessary for product development;
Deadline for collection of the budget;
Product features: attributes, right type, filing date, application number, date of grant, kind of patent, territorial coverage of the patent.
Cost.

In one embodiment, the method comprises a step of certification of modifications. During the step of certification of changes, the apparatus receives a request for time stamp from a user. In the step of certification of modifications, the apparatus generates a file in non-editable format including the contents inserted in the notice board. This time stamp contains the date and time of the content sharing. In one embodiment of the method, during the step of certification of modifications, the apparatus receives a digital signature from the user who has modified the notice board.

The digital signature allows to link the property of the intellectual content to a specific person, avoiding the misappropriation of the intellectual content.

In particular, in one embodiment, the digital signature is a visual recognition performed by webcam.

In one embodiment, the method comprises a purchase step.

The purchase step may include one or more of the following steps:
Choice of the product or of the intellectual content to be purchased from the notice board module.
Buyer verification and authentication;
Entering of the delivery address;
Request for acceptance of sales conditions and/or privacy regulations;
Execution of payment through techniques known to the skilled person, such as satellite websites carrying out online transactions (PayPal, Stripe);
Displaying of the outcome of payment.

In one embodiment, the method comprises a feedback step. In the feedback step, the apparatus records a feedback entered by a user regarding a specific intellectual content and makes it visible on the notice board module by all users who have access to it.

In one embodiment, the method comprises a step of technical support. In this step of technical support, a first computer device receives written questions from a user and saves such written questions to the remote server. In this step of technical support, a second computer device, associated to a service user, designated to support other users, retrieves the questions from the remote server and makes them visible on a screen of the second computer device. In this step of technical support, the second computer device receives written answers from the service user and saves such written answers to the remote server. In such step of technical support, the first computer device retrieves the written answers by the remote server and makes them visible on a screen of the first computer device, so as to complete the assistance to users.

By loading multimedia contents we mean displaying the multimedia contents on the screen of the client device.

More specifically, in one embodiment, during the step of executing the registration module, the control unit collects the search user's compulsory acceptance of confidentiality. More specifically, in one embodiment, the control unit collects the search user's compulsory acceptance of confidentiality only in respect of the multimedia contents viewable by the search user when executing the notice board module. This, on the one hand, allows keeping the secrecy of the intellectual content, for future disclosure if necessary, and on the other hand, protects the owner of the intellectual content who may have recourse to the search user if the search user divulges the intellectual content which the search user has agreed to keep secret.

Further, in one embodiment, the step of executing the advertising module comprises a step of generating a history of the multimedia contents. In one embodiment, the history of the multimedia contents includes at least the date of positing each multimedia content. In one embodiment, the step of executing the advertising module comprises a step of saving the multimedia contents to the remote server. This tells you at any time when a multimedia content was shared for the first time. In one embodiment, the history of the multimedia contents is created by issuing a certified time stamp which provides legal proof that an intellectual content was posted at a given date. In one embodiment, the method comprises a step of emitting a time stamp which certifies the date of any action undertaken by a search user or an advertising user on the apparatus. By any action is meant a posting of a new multimedia content, a sale of an intellectual content, a new registration, a deletion from the remote server of the apparatus, a request for consultancy and any other of the actions that a user can perform thanks to the features of the apparatus described in this disclosure.

The time stamp allows to overcome the drawback of prior art solutions, in which the publication date of the intellectual content is not certified and can be easily falsified.

In one embodiment, after authentication, the apparatus, through the control unit, automatically carries out the step of executing the notice board module if the user is a search user.

In one embodiment, after authentication, the apparatus, through the control unit, automatically carries out the step of executing the advertising module if the user is an advertising user.

In one embodiment, the method comprises a step of translating the vocabulary used by the apparatus to interact with the advertising user or the search user.

In one embodiment, the method comprises a step of geolocating. This step allows geographically tracing the operations performed by the search user or advertising user.

In one embodiment, the method comprises a step of rapid authenticating performed through a specific URL address which provides rapid access to the notice board module or the advertising module.

In one embodiment, the step of executing the notice board module comprises a step of filtering. In one embodiment, during the step of filtering, the control unit filters the multimedia contents as a function of search data which the search user can enter using the input device of the apparatus. The user can enter the search data to select only certain types of intellectual contents. This makes it quicker to search for the operations the user is interested in.

In one embodiment, the step of executing the advertising module comprises a step of checking the multimedia contents. In one embodiment, the step of checking is a step of verifying the originality of the multimedia contents collected compared to the multimedia contents already saved in the remote server. In one embodiment, the step of checking is a step of verifying the lawfulness of the multimedia contents. This, on the one hand, prevents advertising of repetitive intellectual contents and, on the other, prevents advertising intellectual contents contrary to good practice.

In one embodiment, the step of executing the notice board module comprises a step of executing a preview module. In one embodiment, the step of executing the preview module comprises partly loading the multimedia contents. Partly means that the multimedia content is displayed in a way as not to allow the intellectual content to be reproduced. This allows the search user to partly assess the contents of the remote server before subscribing to the registration data.

In one embodiment, the method comprises a step of executing an alert module. In one embodiment, the step of executing the alert module comprises a step of collecting alert data. In one embodiment, the step of executing the alert module comprises a step of notification scheduling as a function of the alert data. In one embodiment, the step of executing the alert module comprises a step of sending notifications to the search user. This allows the search user to set specific alert data with which the control unit automatically schedules the notifications which notify the user of the new entry of multimedia contents corresponding to the alert data.

In one embodiment, the method comprises a step of executing a communication module. In one embodiment, this step includes a step of collecting messages. In one embodiment, the step of executing the communication module includes a step of saving the messages to the remote server. In one embodiment, the step of executing the communication module includes a step of loading the messages on the communication module.

This allows users to interact with each other by asking questions and providing explanations as to the intellectual contents communicated.

In one embodiment, the method comprises a step of executing a negotiation module. In one embodiment, this step includes a step of collecting negotiating proposals. In one embodiment, the step of executing the negotiation module includes a step of saving the negotiating proposals to the remote server. In one embodiment, the step of executing the negotiation module includes a step of loading the negotiating proposals on the negotiation module. This allows the advertising user to start bargaining with the search user to put the advertising user's intellectual content to good use directly from the apparatus.

In one embodiment, the step of collecting negotiating proposals comprises collecting one or more of the following data items:
amount of the loan;
information regarding the multimedia content during bargaining;
contract terms;
value added tax;
availability of multimedia content.

In one embodiment, the step of collecting negotiating proposals comprises a step of concluding negotiations.

In one embodiment, the step of concluding negotiations comprises a step of the control unit automatically generating a digital invoice, automatically saved in the advertising module of the specific advertising user and sent automatically to the search user with whom the negotiations have been concluded.

In one embodiment, the step of concluding negotiations comprises a step of the control unit automatically modifying the specifications of the intellectual content. More specifically, the step of concluding negotiations comprises a step of transferring title to the intellectual content to the search user who concluded the negotiations. In one embodiment, the control unit modifies the information on the remote server and, consequently, modifies the contents displayed on the advertising module and on the notice board module, physically preventing double sales between users registered with the apparatus.

The step of concluding negotiations comprises a step of issuing a time stamp certifying that the sale has been concluded and of recording of the transaction in the closed circle of users registered with the apparatus.

In one embodiment, the method comprises a step of executing a consultancy module. In one embodiment, the step of executing the consultancy module comprises a step of collecting requests for consultancy. In one embodiment, the step of executing the consultancy module incudes a step of saving requests for consultancy to the remote server. In one embodiment, the step of executing the consultancy module incudes a step of loading requests for consultancy on the consultancy module. This allows both the search user and the advertising user to contact a consultant user who, for a fee or free of charge, can suggest commercial, legal or technical strategies rapidly and directly from the apparatus.

In one embodiment, the method comprises a step of statistical processing. The step of statistical processing comprises a step of collecting (counting) the visits to one specific advertising module of an advertising user. In one embodiment, the step of statistical processing processes the display data from the step of collecting the visits, and processes the approval statistics of the specific content posted by the advertising user.

This disclosure also provides an apparatus for communicating intellectual contents. In one embodiment, the apparatus comprises at least two client devices. By client device is meant a computer device capable of processing digital contents: for example, but not limited to, a computer, a tablet, a smartphone or the like. In one embodiment, each client device comprises a control unit. In one embodiment, the control unit is programmed to execute computer instructions. In one embodiment, each client device comprises a screen, configured to make the intellectual contents displayable. In one embodiment, each client device comprises an input device configured to allow a search user or an advertising user to interact with the control unit. By input device is meant any tool which makes it possible to interact with the client device to control the operation thereof: for example, but not limited to, a printer, a mouse, a trackpad or a joystick. In one embodiment, the apparatus comprises, for each client device, a modem, configured provide an Internet connection for the respective client device.

In one embodiment, the apparatus comprises a remote server. In one embodiment, the remote server is connected to each client device through an Internet connection. In one embodiment, the remote server is configured to save digital contents.

By multimedia contents we mean any set of computer data which, when suitably converted by the control unit, can transmit information to the user as to the nature of a specific intellectual content such as, for example, but not limited to, photos, videos, audios or text files.

In one embodiment, the apparatus comprises, for each client device, a registration module of a search user or an advertising user. The term “module”, on the other hand, is used to indicate a part of the apparatus which comprises specific graphics, logic and code lines corresponding to activities executed by the control unit on the other components of the apparatus for communicating intellectual contents. By “search user” is meant a user who uses the apparatus to search for intellectual contents advertised for use by other users. By “advertising user” is meant a user who uses the apparatus to advertise their intellectual contents in such a way that they can be viewed by other users interested in utilizing the intellectual contents. In one embodiment, the registration module is displayable on the screen of the respective client device. In one embodiment, the registration module is configured to collect registration data. The registration data are private data which both the search user and the advertising user must provide the apparatus with before they can use the functions of the apparatus.

In one embodiment, the apparatus comprises, for each client device, an access module for the search user or the advertising user. In one embodiment, the access module is displayable on the screen of the respective client device. In one embodiment, the registration module is configured to collect access data. In one embodiment, the access module is configured to check the matching between the registration data and the access data for the search user or the advertising user.

In one embodiment, the apparatus comprises an advertising module for each client device. In one embodiment, the advertising module is displayable on the screen of the respective client device. In one embodiment, the advertising module is configured to collect multimedia contents which can be posted by the advertising user. By advertising module, in one embodiment, we mean a module configured to show only the multimedia contents posted by the specific advertising user. In one embodiment, by advertising module we mean a module configured to show only the multimedia contents posted by the specific advertising user and to collect further multimedia contents posted by the specific advertising user.

In one embodiment, the apparatus comprises a notice board module for each client device. In one embodiment, the notice board module is displayable on the screen of the respective client device. In one embodiment, the notice board module is configured to load the multimedia contents and to make them displayable by the search user.

More specifically, in one embodiment, the registration module comprises an acceptance field. In one embodiment, the acceptance field is programmed to compulsorily collect the acceptance of a confidentiality (non-disclosure) agreement of the search user. In one embodiment, the confidentiality (non-disclosure) agreement covers only the multimedia contents viewable by the search user on the notice board module. In one embodiment, the advertising module comprises a date field. In one embodiment, the date field is programmed to generate a history of the multimedia contents. In one embodiment, the history of the multimedia contents includes at least the date of posting each multimedia content.

In one embodiment, each notice board module comprises a plurality of filters. In one embodiment, the plurality of filters is programmed to filter the multimedia contents as a function of search data. The user can enter the search data to select only certain types of intellectual contents.

In one embodiment, each notice board module comprises a preview module. In one embodiment, the preview module is displayable on the screen of the respective client device. In one embodiment, the preview module is programmed to load the multimedia contents only partly. In one embodiment, each notice board module comprises a description module. In one embodiment, the description module is displayable on the screen of the respective client device. In one embodiment, the description module is programmed to load the multimedia contents in full.

In one embodiment, the apparatus comprises an alert module for each client device.

In one embodiment, each client device comprises a loudspeaker configured to emit notification sounds. In one embodiment, the alert module is displayable on the screen of the respective client device. In one embodiment, the alert module is configured to collect alert data. In one embodiment, the alert module is configured to schedule the notification sounds as a function of the alert data. In one embodiment, the alert module is configured to send the notification sounds to the search user. The term “notification sounds” is used to mean local or remote notifications on the client device which tell the search user to the presence of a new intellectual content which matches the alert data entered by the same search user.

In one embodiment, the apparatus comprises a communication module. In one embodiment, the communication module is displayable on the screen of the respective client device. In one embodiment, the communication module is configured to collect or load messages of a search user or advertising user.

In one embodiment, the apparatus comprises a negotiation module. In one embodiment, the negotiation module is displayable on the screen of the respective client device. In one embodiment, the negotiation module is configured to collect proposals from a search user and to load the proposals so they can be viewed by an advertising user.

In one embodiment, the apparatus comprises a consultancy module. In one embodiment, the consultancy module is displayable on the screen of the respective client device. In one embodiment, the consultancy module is configured to collect requests for consultancy from a user and to make the requests for consultancy viewable by a user.

In one embodiment, the request for consultancy is a request for commercial intermediation. In one embodiment, the request for consultancy is a request for a technical opinion. In one embodiment, the request for consultancy is a request for a technical opinion.

### BRIEF DESCRIPTION OF THE DRAWINGS

These and other features will become more apparent from the following detailed description of a preferred embodiment, illustrated by way of non-limiting example in the accompanying drawings, in which:

FIG. 1 illustrates an apparatus for communicating intellectual contents;

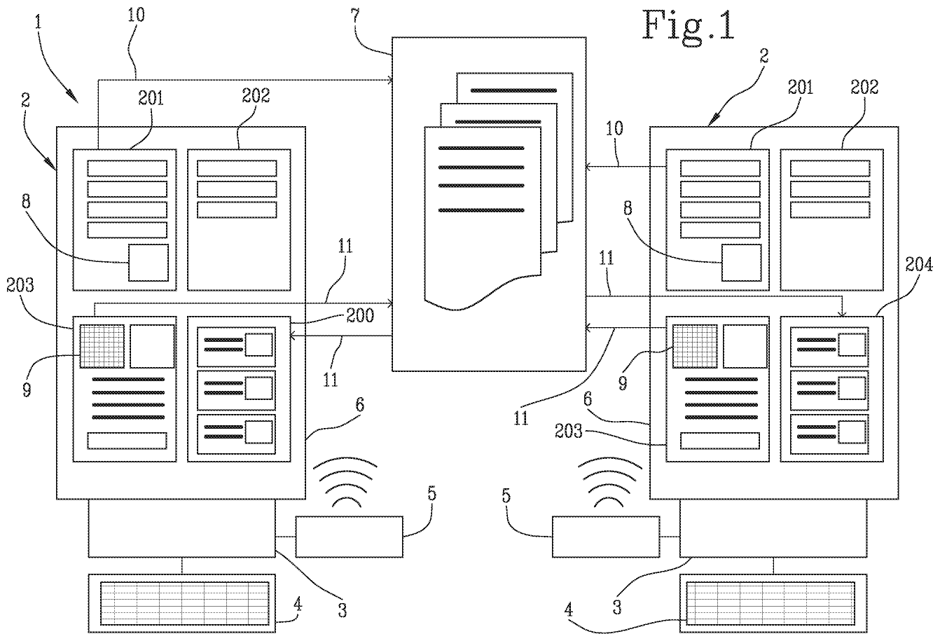

FIG. 2 illustrates a notice board module of the apparatus for communicating intellectual contents;

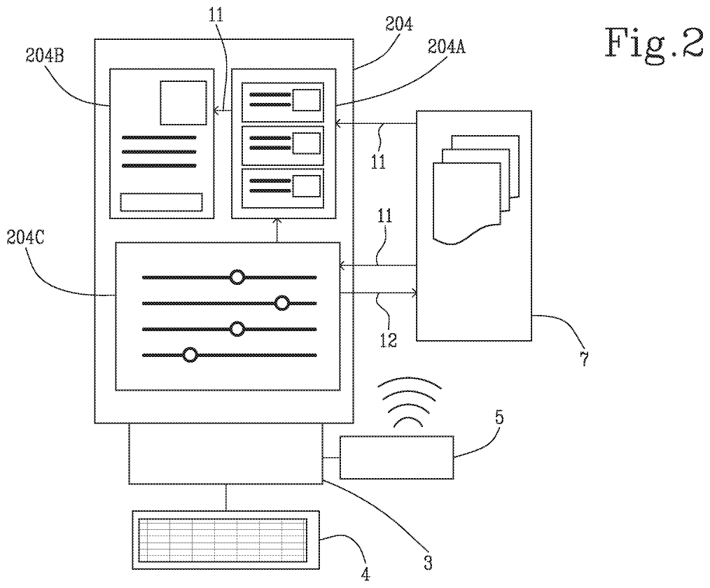

FIG. 3 illustrates an embodiment of the apparatus of FIG. 1;

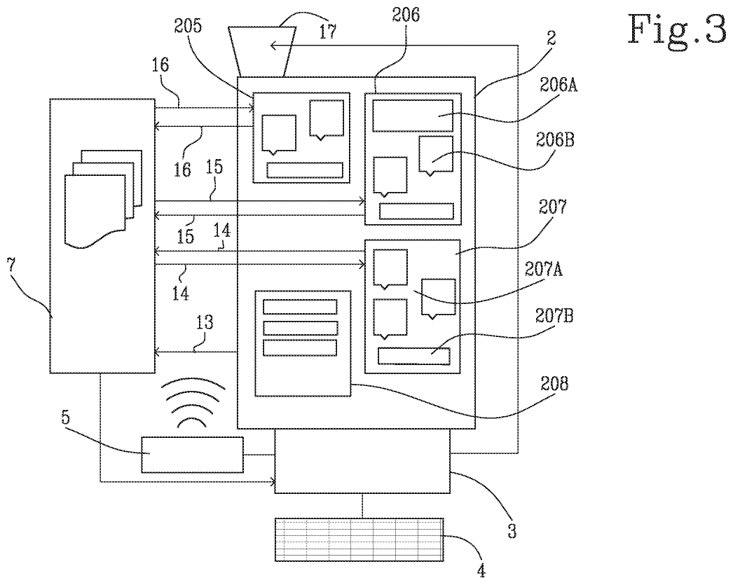

FIG. 4 illustrates a method for communicating intellectual contents from a functional viewpoint;

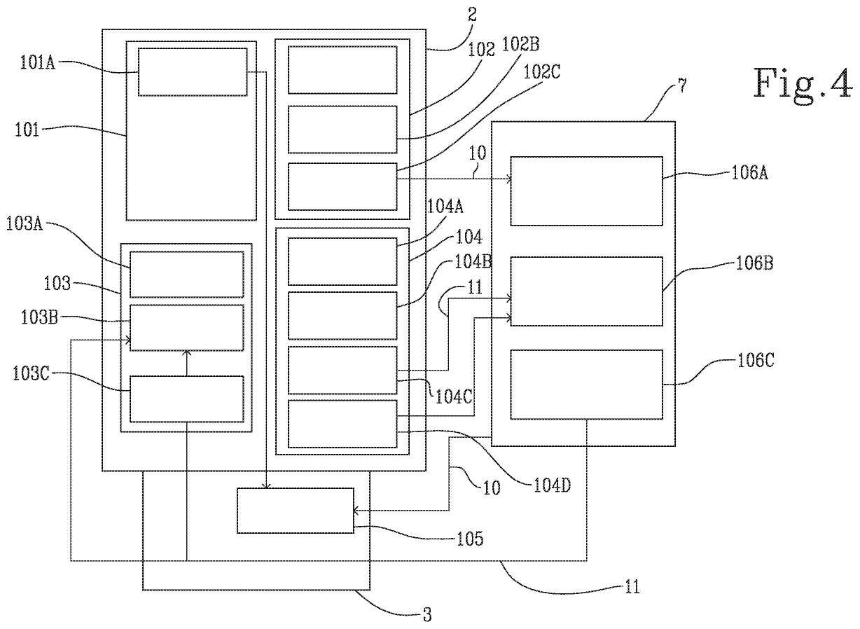

FIG. 5 illustrates a variant embodiment of the method of FIG. 4.

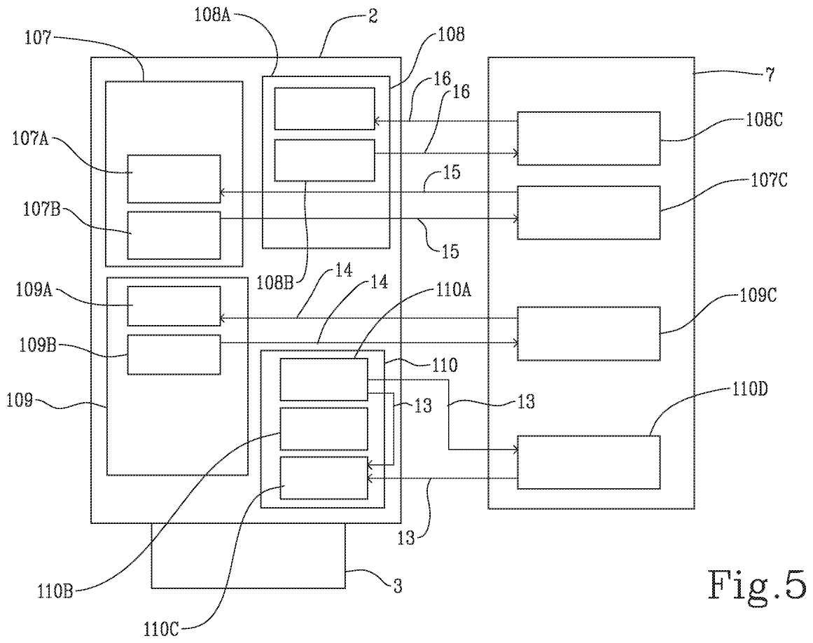

### DETAILED DESCRIPTION OF PREFERRED EMBODIMENTS OF THE INVENTION

With reference to the accompanying drawings, the numeral 1 denotes an apparatus for communicating intellectual contents. In one embodiment, the apparatus 1 comprises a client device 2. In this embodiment, communication is between two users who interact through the same client device 2 at different times. In a preferred embodiment, the apparatus 1 comprises at least two client devices. In effect, the apparatus 1 is also used for communication between users of different origin and location operating on different client devices. In one embodiment, the apparatus 1 comprises a plurality of client devices. Hereinafter, having clarified that the apparatus 1 may comprise a plurality of client devices, we will refer to a single client device 2 to represent each and every client device 2 included in the apparatus 1. In effect, from the constructional and functional viewpoint, each client device 2 offers the same functions, which are selectable as a function of the type of user using the client device 2. In one embodiment, the client device 2 is a smartphone. In one embodiment, the client device 2 is a computer. In one embodiment, the client device 2 is a tablet.

In one embodiment, the client device 2 comprises a control unit 3. In one embodiment, the control unit 3 is a processor configured to execute computer code instructions in any one of the computer languages known in the technical sector.

In one embodiment, the client device 2 comprises at least one input device. In one embodiment, the input device is a keyboard 4. In one embodiment, the input device is a mouse. In one embodiment, the input device is a trackpad. In one embodiment, the input device is a joystick. The input device is connected to the control unit 3 to allow the user to interact with the apparatus 1.

In one embodiment, the apparatus 1 comprises a modem 5. The modem 5 allows the client device 2 to remain connected to the Internet at all times.

In one embodiment, the apparatus 1 comprises a screen 6.

In one embodiment, the apparatus 1 comprises a remote server 7. In one embodiment, the remote server 7 is configured to save computer data from the plurality of client devices and to send the computer data in response to a request from the client device 2.

In one embodiment, the apparatus 1 comprises a registration module 201.

In one embodiment, the registration module 201 comprises a graphical part and a code part. In one embodiment, the control unit 3 of the apparatus 1 is configured to execute the code part of the registration module 201. In one embodiment, the graphical part of the registration module 201 is displayable on the screen 6 of the apparatus 1. In one embodiment, the registration module 201 is configured to collect the data of a user who wishes to use the apparatus 1. In one embodiment, the registration module 201 comprises a plurality of digital labels. The digital labels allow users to find their way within the registration module 201. In one embodiment, the registration module 201 comprises a plurality of text boxes. The text boxes allow a user to enter registration data 10. In one embodiment, the registration data 10 comprise one or more of the following items of information:
name, surname, address, residence, domicile, telephone number
copy of identity card
business name, VAT number
email address, password and nickname correlated with the use of the apparatus 1
credit card number, credit card expiry date and credit card holder's name.

In one embodiment, the registration module 201 comprises at least one acceptance field. 8. In one embodiment, the acceptance field 8 comprises a text part, in which the essence of the agreement being undertaken is described, and an acceptance part in which the user subscribes to what is described in the text part. In one embodiment, the text part regards the undertaking of a confidentiality (non-disclosure) agreement in respect of any document that is subsequently displayed in any module forming part of the apparatus 1. In one embodiment, the text part regards the rights reserved to the user who will subsequently be allowed to upload their intellectual contents to the apparatus 1. In one embodiment, the text part regards the rights to the privacy and use of the sensitive data entered by the user in the registration module 201.

In one embodiment, the registration module 201 is configured to send the registration data 10 to the remote server 7. In one embodiment, the registration module 201 is configured to send the confidentiality (non-disclosure) agreement to the remote server 7. In one embodiment, the remote server 7 comprises a plurality of computer security systems to guarantee the unattackability of the confidentiality (non-disclosure) agreement.

In one embodiment, the apparatus 1 comprises an access module 202. In one embodiment, the access module 202 comprises a graphical part and a code part. In one embodiment, the control unit 3 of the apparatus 1 is configured to execute the code part of the access module 202. In one embodiment, the graphical part of the access module 202 is displayable on the screen 6 of the apparatus 1. In one embodiment, the access module 202 is configured to collect access data with each access by a user. In one embodiment, the access module 202 comprises a plurality of text boxes. The text boxes allow a user to enter access data. The access data are at least partly the same as the registration data 10. More specifically, the access data may be one or more of the following items:
email address
password
nickname.

The function of the access module 202 is to collect the access data to send them to the control unit 3 which may perform all the checks needed to authenticate the user who is making the access request.

In one embodiment, the apparatus 1 comprises an advertising module 203. In one embodiment, the advertising module 203 comprises a graphical part and a code part. In one embodiment, the control unit 3 of the apparatus 1 is configured to execute the code part of the advertising module 203. In one embodiment, the graphical part of the advertising module 203 is displayable on the screen 6 of the apparatus 1. In one embodiment, the advertising module 203 comprises a plurality of text boxes. In one embodiment, the advertising module 203 comprises a plurality of image boxes or video boxes. The plurality of text boxes and image or video boxes allow an advertising user to fully and clearly explain their intellectual contents by posting multimedia contents 11.

In one embodiment, the multimedia contents 11 may comprise one or more of the following contents:
title of the intellectual content
description of the intellectual content
photo of the prototype
video of the prototype or method
collaborators, if any
suggestions, if any, as to how and when to use the intellectual content.

By multimedia contents 11 we mean any set of computer data which, when suitably converted by the control unit 3, can transmit information to a search user or advertising user as to the nature of a specific intellectual content such as, for example, but not limited to, photos, videos, audios or text files. By advertising user we mean a user who uses the apparatus 1 to share their intellectual contents. By search user we mean a user who uses the apparatus 1 to look for intellectual contents of interest to them. In one embodiment, the advertising module 203 comprises a date field 9, configured to enter a posting date. In one embodiment, the advertising module 203 is configured to generate a history 11′ correlated with a specific intellectual content as a function of the posting date. In one embodiment, the apparatus 1 comprises date fields 9 also in other modules such, for example, but not limited to, a modify module, not illustrated in the drawings and configured to modify the multimedia contents 11 of a specific intellectual content. In such a case, the date field 9 is configured to enter a modify date, which allows updating the history 11′.

In one embodiment, the advertising module 203 is configured to transmit to the remote server 7 the multimedia contents 11 and the history 11′ associated therewith. In one embodiment, the plurality of computer security systems of the remote server 7 guarantee the security and unattackability of the multimedia contents 11 and of the history 11′ associated therewith.

In one embodiment, the apparatus 1 comprises a notice board module 204. In one embodiment, the notice board module 204 comprises a graphical part and a code part. In one embodiment, the control unit 3 of the apparatus 1 is configured to execute the code part of the notice board module 204. In one embodiment, the graphical part of the notice board module 204 is displayable on the screen 6 of the apparatus 1.

In one embodiment, the notice board module 204 is configured to load the multimedia contents 11 and to make them displayable by the search user on the screen 6 of the apparatus 1. In one embodiment, the notice board module 204 is not displayable until after the authentication process 105 on the access module 202 of the apparatus 1 has been completed.

In one embodiment, the notice board module 204 comprises a preview module 204A. In one embodiment, the preview module 204A is configured to make the multimedia contents 11 correlated with a specific intellectual content displayable only partly. In one embodiment, the preview module 204A is displayable even without completing the authentication process 105 on the access module 202 of the apparatus 1. Indeed, in such a case, the information contained in the preview module 204A is not sufficient to reproduce the intellectual content. In one embodiment, the preview module 204A is displayable only after completing the authentication process 105 on the access module 202 of the apparatus 1. In one embodiment, the preview module 204A comprises the title of the intellectual content, the technical field the intellectual content addresses and a significant photo representing it. In one embodiment, the notice board module 204 comprises a description module 204B.

In one embodiment, the description module 204B is configured to make the multimedia contents 11 correlated with a specific intellectual content displayable in full. In one embodiment, the description module 204B is displayable only after completing the authentication process 105 on the access module 202 of the apparatus 1. Indeed, in such a case, the information contained in the description module 204B is sufficient to reproduce the intellectual content and it is compulsory for the search user to have subscribed to the confidentiality (non-disclosure) agreement.

In one embodiment, the notice board module 204 comprises a plurality of filters 204C. In one embodiment, the plurality of filters 204C are configured to allow the search user to speed up a search for the intellectual contents they are interested in. In one embodiment, the plurality of filters 204C can be set on one or more of the following features:
technical field;
geographical position;
specific application within the technical field.

The features set using the filters 204C of the notice board module 204 define the search data 12. In one embodiment, the control unit 3 is configured to update the multimedia contents 11 loaded on the preview module as a function of the search data 12. In one embodiment, the remote server 7 is configured to transmit only the multimedia contents 11 which match the search data 12.

In one embodiment, the apparatus 1 comprises an alert module 208. In one embodiment, the alert module 208 comprises a graphical part and a code part. In one embodiment, the control unit 3 of the apparatus 1 is configured to execute the code part of the alert module 208. In one embodiment, the graphical part of the alert module 208 is displayable on the screen 6 of the apparatus 1. In one embodiment, the alert module 208 is configured to collect alert data 13. The alert data 13 are data which can be entered by a search user and which express preferences on the preferred intellectual contents. In one embodiment, the search data 12 may be used as alert data 13 automatically by the apparatus 1.

In one embodiment, the remote server 7 is configured to receive and save the alert data 13. In one embodiment, the remote server 7 is configured to send the alert data 13 in response to a request from the control unit 3.

In one embodiment, the apparatus 1 comprises a loudspeaker 17.

In one embodiment, the alert module 208 is configured to schedule notification sounds as a function of the alert data 13.

In one embodiment, the control unit 3 is configured to send a notification sound schedule to the loudspeaker 17. The loudspeaker 17 is configured to alert the search user as a function of the notification sound schedule received.

In one embodiment, the apparatus 1 comprises a communication module 207. In one embodiment, the communication module 207 comprises a graphical part and a code part. In one embodiment, the control unit 3 of the apparatus 1 is configured to execute the code part of the communication module 207. In one embodiment, the graphical part of the communication module 207 is displayable on the screen 6 of the apparatus 1.

In one embodiment, the communication module 207 comprises a display screen 207A. In one embodiment, the communication module 207 comprises a send box 207B.

In one embodiment, the communication module 207 is configured to collect messages 14. In one embodiment, the communication module 207 is configured to transmit messages 14 to the remote server 7. In one embodiment, the remote server 7 is configured to save the messages 14. In one embodiment, the remote server 7 is configured to send the messages 14 to the client device 2 in response to a specific request from the control unit 3. In one embodiment, the display screen 207A is configured to show the messages 14 already saved in the remote server 7. In one embodiment, the send box 207B is configured to receive a message of a user through the keyboard 4. In one embodiment, the control unit 3 comprises a moderator module, not illustrated in the drawings, configured to automatically filter the contents of the messages 14 as a function of the rules accepted in the registration module 201.

In one embodiment, the apparatus 1 comprises a consultancy module 206. In one embodiment, the consultancy module 206 comprises a graphical part and a code part. In one embodiment, the control unit 3 of the apparatus 1 is configured to execute the code part of the consultancy module 206. In one embodiment, the graphical part of the consultancy module 206 is displayable on the screen 6 of the apparatus 1.

In one embodiment, the consultancy module 206 comprises a cover page 206A. In one embodiment, the communication module 207 comprises a commentary 206B.

In one embodiment, the communication module 207 is configured to collect requests for consultancy 15. In one embodiment, the communication module 207 is configured to transmit requests for consultancy 15 to the remote server 7. In one embodiment, the communication module 207 is configured to transmit opinions of consultant users to the remote server 7. In one embodiment, the remote server 7 is configured to save the requests for consultancy 15 and the opinions. In one embodiment, the remote server 7 is configured to send the requests for consultancy 15 and the opinions to the client device 2 in response to a specific request from the control unit 3. In one embodiment, the cover page 206A is configured to show a specific request for consultancy already saved in the remote server 7. In one embodiment, the commentary 206B is configured to allow the consultant user to enter their opinion regarding the request for consultancy displayable on the cover page 206A. In one embodiment, the commentary 206B is configured to allow a user to display all the opinions regarding the request for consultancy displayable on the cover page 206A. In one embodiment, the moderator module of the control unit 3 is configured to automatically filter the contents of the requests for consultancy 15 and the opinions as a function of the rules accepted in the registration module 201.

In one embodiment, the apparatus 1 comprises a negotiation module 205. In one embodiment, the negotiation module 205 comprises a graphical part and a code part. In one embodiment, the control unit 3 of the apparatus 1 is configured to execute the code part of the negotiation module 205. In one embodiment, the graphical part of the negotiation module 205 is displayable on the screen 6 of the apparatus 1.

In one embodiment, the negotiation module 205 is configured to collect negotiating proposals 16. In one embodiment, the negotiation module 205 is configured to transmit negotiating proposals 16 to the remote server 7. In one embodiment, the remote server 7 is configured to save the negotiating proposals 16. In one embodiment, the remote server 7 is configured to send the negotiating proposals 16 to the client device 2 in response to a specific request from the control unit 3. In one embodiment, the negotiation module 205 is configured to show the messages 14 already saved in the remote server 7. In one embodiment, the negotiation module 205 is configured to receive negotiating proposals 16 of a user through the keyboard 4. In one embodiment, the moderator module of the control unit 3 is configured to automatically filter the contents of the negotiating proposals 16 as a function of the rules accepted in the registration module 201.

This disclosure also provides a method for communicating intellectual contents using an apparatus 1 for communicating intellectual contents. In one embodiment, the method comprises a step of preparing a remote server 7 and a client device 2 including a screen 6, an input device and a control unit 3.

In one embodiment, the method comprises a step of executing a registration module 102. This step comprises executing a code part of the registration module 201. The step of executing a code part of the registration module 201 comprises generating a graphical part, displayed on the screen 6 of the client device 2.

In one embodiment, the step of executing a registration module 102 comprises a step of collecting registration data 102A. During this step, the control unit 3 receives the inputs from the input device and associates the inputs with the registration data 10.

In one embodiment, the step of collecting registration data 102A comprises a step of collecting confidentiality 102B.

In one embodiment, during the step of collecting confidentiality 102B, the control unit 3 compulsorily collects the user's confidentiality (non-disclosure) agreement. In one embodiment, the confidentiality (non-disclosure) agreement is extended to all the contents saved in the remote server 7 of the apparatus 1. In one embodiment, the confidentiality (non-disclosure) agreement is extended only to the contents saved in the remote server 7 of the apparatus 1 and viewable by the user. During the step of collecting confidentiality 102B, the control unit 3 displays on the registration module 201 an acceptance field 8 including a text part, in which the essence of the agreement being undertaken is described, and an acceptance part in which the user subscribes to what is described in the text part. The text part clearly explains the nature and limitations of the confidentiality (non-disclosure) agreement in respect of any document that is subsequently displayed in any module forming part of the apparatus 1.

The step of executing the registration module 102 terminates only if the step of collecting confidentiality 102B terminates positively. If it does not, the control unit 3 generates an automatic error notice.

If the subscribes to the acceptance field 8, the method comprises a step of transmitting registration data 102C to the remote server 7.

In one embodiment, the method comprises a step of saving registration data 106A to the remote server 7 and creates a memory space dedicated to the user the registration data 10 refer to.

In one embodiment, the method comprises a step of executing an access module 101. In one embodiment, the step of executing the alert module 101 comprises a step of collecting access data. The access data are entered in specific text boxes on the access module 202.

In one embodiment, the method comprises a step of authenticating 105.

The step of authenticating 105 consists in checking the matching between the access data and the registration data 10. More specifically, on the one hand, the control unit 3 sends a request to the remote server 7 containing the set of all the registration data 10 of all the registered users and, on the other, the control unit 3 receives the access data from the access module 202. If the control unit 3 verifies the matching of the access data within the set of all the registration data 10, the step of authenticating 105 is concluded positively and the user can proceed to using the apparatus 1. On the other hand, if the access data do not match any of the values of the registration data 10, the control unit 3 automatically generates an error notice and prevents the apparatus 1 from being used. In one embodiment, the error notice directs the user to the registration module 201 to proceed with the step of collecting registration data 102A on the registration module 201.

In one embodiment, the method comprises a step of executing an advertising module 104.

In one embodiment, the step of executing the advertising module 104 comprises a step of collecting multimedia contents 104A. The multimedia contents 11 are entered by the user in specific text boxes, image boxes or audio boxes. The term “box” as used in this context denotes a graphical space and a memory space in which to allocate a certain number of information bits which can be converted into multimedia contents 11.

In one embodiment, the step of executing the advertising module 104 comprises a step of checking the multimedia contents 104B. In one embodiment, this check is performed by the control unit 3 by verifying the multimedia contents 11 against all those already saved in the remote server 7 to ensure that the multimedia content being collected is not already present.

In one embodiment, this check verifies the lawfulness of the multimedia content being collected.

In one embodiment, the step of executing the advertising module 104 comprises a step of transmitting the multimedia contents 104C to the remote server 7. The step of transmitting the multimedia contents 11 is performed only if the step of checking the multimedia contents 104B has a positive outcome.

In one embodiment, the step of executing the advertising module 104 comprises a step of generating a history 104D of the multimedia content. The step of generating a history 104D of the multimedia content is performed by means of a date field 9 present on the advertising module 203 which allows uniquely associating the multimedia content with a date of posting. In one embodiment, the method comprises a step of modifying the history 11′. This step is carried out, for example, when an advertising user decides to modify the multimedia content. In such a case, the control unit 3 of the client device 2 changes the date of posting to a date of modifying.

In one embodiment, the method comprises a step of saving multimedia contents 106B to the remote server 7. This step also includes saving to the remote server 7 the history 11′ associated with each multimedia content.

In one embodiment, the method comprises a step of executing a notice board module 103.

In one embodiment, the method comprises a step of sending multimedia contents 106C from the remote server 7 to the notice board module 204.

In one embodiment, the step of executing the notice board module 103 comprises a step of executing a preview module 103C. In this step, the multimedia contents 11 from the remote server 7 are loaded only partly on the preview module 204A.

In one embodiment, the step of executing the notice board module 103 comprises a step of loading multimedia contents 103B. In this step, the multimedia contents 11 are loaded in full, to the extent that a search user can understand them clearly and, if necessary, can reproduce the intellectual content they convey. In one embodiment, the notice board module 204 verifies the user's authentication 105 and automatically decides whether to send it to the preview module 204A or to a description module 204B in which the step of loading multimedia contents 103B is carried out.

In one embodiment, the step of executing the notice board module 103 comprises a step of filtering 103B the multimedia contents 11. During this step, the control unit 3 receives search data 12 from the notice board module 204 in which the filters 204C are allocated.

In one embodiment, the control unit 3 receives the search data 12 from the notice board module 204 and all the multimedia contents 11 from the server. Next, by processing the search data 12 and according to a filtering algorithm 103A, the control unit 3 sends to the notice board module 204 only the multimedia contents 11 which match the search data 12.

In one embodiment, the notice board module 204 sends the search data 12 to the control unit 3 which, as a function of the search data 12, processes a specific request to be sent to the remote server 7. The specific request allows receiving from the remote server 7 only those multimedia contents 11 that match the search data 12.

In one embodiment, the method comprises a step of executing a consultancy module 107. In one embodiment, the step of executing the consultancy module 107 comprises a step of collecting requests for consultancy 107A. In one embodiment, during the step of collecting requests for consultancy 107A, the consultancy module 206 collects requests for consultancy 15 and saves them to the remote server 7.

In one embodiment, during the step of collecting requests for consultancy 107A, the consultancy module 206 collects opinions of consultant users associated with a request for consultancy and saves them to the remote server 7.

In one embodiment, the method comprises a step of saving requests for consultancy 107C to the remote server 7.

In one embodiment, during the step of saving the requests for consultancy 107C, the remote server 7 saves the opinions of the consultant users. In one embodiment, during the step of saving the requests for consultancy 107C, the remote server 7 saves the requests for consultancy 15 of the users needing consultancy. In one embodiment, the remote server 7 sends the opinions and requests for consultancy 15 to the consultancy module 206 in response to a request from the control unit 3.

In one embodiment, the step of executing the consultancy module 107 comprises a step of loading requests for consultancy 107B.

In one embodiment, during the step of loading requests for consultancy 107B, the consultancy module 206 loads the requests for consultancy 15 and displays them on the screen 6 of the client device 2.

In one embodiment, during the step of loading requests for consultancy 107B, the consultancy module 206 loads the opinions associated with a request for consultancy and displays them on the screen 6 of the client device 2.

In one embodiment, during the step of loading requests for consultancy 107B, the consultancy module 206 loads the request for consultancy and the opinions associated therewith.

In one embodiment, the method comprises a step of executing a communication module 108. In one embodiment, the step of executing the communication module 108 comprises a step of collecting messages 108A. In one embodiment, during the step of collecting messages 108A, the communication module 207 collects messages 14 and saves them to the remote server 7.

In one embodiment, the method comprises a step of saving messages 108C to the remote server 7.

In one embodiment, during the step of saving the requests for consultancy 108C, the remote server 7 saves the messages 14 of the users. In one embodiment, the remote server 7 sends the messages 14 to the communication module 207 in response to a request from the control unit 3.

In one embodiment, the step of executing the communication module 108 comprises a step of loading messages 108B.

In one embodiment, during the step of loading messages 108B, the communication module 207 loads the messages 14 and displays them on the screen 6 of the client device 2.

In one embodiment, the method comprises a step of executing a negotiation module 109. In one embodiment, the step of executing the negotiation module 109 comprises a step of collecting negotiating proposals 109A. In one embodiment, during the step of collecting negotiating proposals 109A, the negotiation module 205 collects negotiating proposals 16 and saves them to the remote server 7.

In one embodiment, the method comprises a step of saving negotiating proposals 109C to the remote server 7.

In one embodiment, during the step of saving the negotiating proposals 109C, the remote server 7 saves the negotiating proposals 16 of the users. In one embodiment, the remote server 7 sends the negotiating proposals 16 to the negotiation module 205 in response to a request from the control unit 3.

In one embodiment, the step of executing the negotiation module 109 comprises a step of loading negotiating proposals 109B.

In one embodiment, during the step of loading negotiating proposals 109B, the negotiation module 205 loads the negotiating proposals 16 and displays them on the screen 6 of the client device 2.

In one embodiment, the method comprises a step of executing an alert module 110.

In one embodiment, the step of executing the alert module 110 comprises a step of collecting alert data 110A. In one embodiment, the alert data 13 are sent by the alert module 208 to the control unit 3. In one embodiment, the alert data 13 are sent by the alert module 208 to the remote server 7.

In one embodiment, the method comprises a step of saving alert data 110D to the remote server 7.

In one embodiment, the step of executing the alert module 110 comprises a step of scheduling notifications. In one embodiment, the step of executing the alert module 110 comprises a step of scheduling notification sounds 110C.

In one embodiment, the control unit 3 receives the alert data 13 from the alert module 208, processes them and schedules the notifications to generate a notification schedule. In one embodiment, the control unit 3 performs a step of scheduling notification sounds 110C. In one embodiment, the control unit 3 performs a step of scheduling notification vibrations.

In one embodiment, the control unit 3 sends a request to the remote server 7 to receive from the latter the alert data 13 saved therein. After receiving the alert data 13 from the remote server 7, the control unit 3 proceeds to scheduling the notifications.

In one embodiment, the method comprises a step of emitting notification sounds through a loudspeaker 17 of the client device 2.

In one embodiment, the step of executing the alert module 110 comprises a step of sending notification sounds 110B. After scheduling the notifications as a function of the alert data 13, the control unit 3 sends the notification sound schedule to the loudspeaker 17. As a function of the notification sound schedule, the loudspeaker 17 emits notification sounds to alert the search user to the presence of new intellectual contents potentially of interest to them according to their own settings in the alert module 208.

1-16. (canceled)

17. A method for communicating intellectual contents, the method comprising:
preparing a remote server and a client device including a screen, an input device and a control unit;
executing a registration module through the control unit and collecting registration data of a search user or an advertising user;
transmitting the registration data over a communication network from the client device to the remote server and saving the registration data to the remote server;
executing an access module through the control unit and collecting access data of a search user or an advertising user;
logging in by verifying the match between the registration data and the access data for the search user or the advertising user;
executing an advertising module through the control unit and collecting multimedia contents;
transmitting the multimedia contents over the communication network from the client device to the remote server and saving the multimedia contents to the remote server;
executing a notice board module through the control unit,
transmitting the multimedia contents over the communication network from the remote server to the client device and loading the multimedia contents to the notice board module;
wherein executing the registration module comprises, by the control unit, compulsorily collecting acceptance of a confidentiality (non-disclosure) agreement of the search user in respect only of the multimedia contents visible to the search user during execution of the notice board module, and wherein executing the advertising module comprises generating a history of the multimedia contents including at least one date of posting each multimedia content and saving the history of the multimedia contents to the remote server.

18. The method according to claim 17, wherein executing the notice board module comprises filtering, by the control unit, the multimedia contents as a function of search data entered by the search user through the input device of the apparatus.

19. The method according to claim 17, wherein executing the advertising module comprises checking the multimedia contents to verify that the multimedia contents collected are original compared to the multimedia contents already saved in the remote server.

20. The method according to claim 17, wherein executing the notice board module comprises executing a preview module where the multimedia contents are only partly loaded.

21. The method according to claim 17 comprising:
executing an alert module through the control unit, wherein executing the alert module through the control unit comprises collecting alert data, scheduling notifications as a function of the alert data, and sending the notifications to the search user.

22. The method according to claim 17 comprising:
executing a communication module, wherein executing the communication module comprises collecting messages, saving messages to the remote server, and loading messages to the communication module.

23. The method according to claim 17 comprising:
executing a negotiation module, wherein executing the negotiation module comprises collecting negotiating proposals, saving negotiating proposals to the remote server and loading negotiating proposals to the negotiation module.

24. The method according to claim 17 comprising:
executing a consultancy module, wherein executing the consultancy module comprises collecting requests for consultancy, saving requests for consultancy to the remote server, and loading requests for consultancy to the consultancy module.

25. An apparatus for communicating intellectual contents, the apparatus comprising:
at least two client devices, each including:
a control unit programmed to execute computer-executable instructions stored in a non-transitory computer-readable medium,
a screen that displays the intellectual contents, and
an input device that allows a search user or an advertising user to interact with the control unit;
for each client device, a modem configured to provide the respective client device with a connection with a remote device over a communication network;
a remote server connected to each client device over the communication network and programmed to save digital contents;
for each client device, a registration module for a search user or an advertising user, displayable on the screen of the respective client device and programmed to collect registration data;
for each client device, an access module for the search user or the advertising user, displayable on the screen of the respective client device, the access module being programmed to collect access data and to verify that the registration data match the access data for the search user or the advertising user;
for each client device, an advertising module displayable on the screen of the respective client device and programmed to collect multimedia contents which can be entered by the advertising user;
for each client device, a notice board module displayable on the screen of the respective client device and programmed to load the multimedia contents and to make them displayable by the search user;
wherein the registration module comprises an acceptance field programmed to compulsorily collect the acceptance of a confidentiality (non-disclosure) agreement of the search user in respect only of the multimedia contents visible to the search user on the notice board module, and the advertising module comprises a date field, and the advertising module is programmed to generate a history of the multimedia contents including at least one date of posting the multimedia contents.

26. The apparatus according to claim 25, wherein each notice board module comprises a plurality of filters programmed to filter the multimedia contents as a function of search data.

27. The apparatus according to claim 25, wherein each notice board module comprises a preview module displayable on the screen of the respective client device and programmed to load the multimedia contents only partly, and a descriptive module displayable on the screen of the respective client device and programmed to load the multimedia contents in their entirety.

28. The apparatus according to claim 25, comprising, for each client device, a loudspeaker and an alert module displayable on the screen of the respective client device and programmed to collect alert data, to schedule notification sounds as a function of the alert data and to send the notification sounds to the search user.

29. The apparatus according to claim 25, wherein each client device comprises a loudspeaker configured to emit notification sounds.

30. The apparatus according to claim 25, comprising, for each client device, a communication module displayable on the screen of the respective client device and programmed to collect or load messages of a search user or an advertising user.

31. The apparatus according to claim 25, comprising, for each client device, a negotiation module displayable on the screen of the respective client device and programmed to collect negotiating proposals from a search user and to load the negotiating proposals for display to an advertising user.

32. The apparatus according to claim 25, comprising, for each client device, a consultancy module displayable on the screen of the respective client device and programmed to collect requests for consultancy and to load the requests for consultancy for display to a consultant user.

33. The apparatus according to claim 25, comprising, for each client device, an advertising module displayable on the screen of the respective client device and programmed to generate a history of the multimedia contents and wherein the apparatus is programmed to emit a time stamp which certifies the date of any action undertaken by a search user or an advertising user on the apparatus.

34. A method for communicating intellectual contents, comprising the following steps:
preparing a remote server and a client device including a monitor, an input device and a control unit;
executing a registration module through the control unit and collecting registration data of a search user or an advertising user;
transmitting registration data over a communication network from the client device to a remote server and saving the registration data to the remote server;
executing an access module through the control unit and collecting access data of the search user or the advertising user;
logging in by verifying the match between the registration data and the access data for the search user or the advertising user;
executing an advertising module through the control unit and collecting multimedia contents through the client device;
transmitting the multimedia contents over the communication network from the client device to the remote server and saving the multimedia contents to the remote server;
executing a notice board module through the control unit, transmitting the multimedia contents over the communication network from the remote server to the client device and loading the multimedia contents to the notice board module through the client device;
wherein executing the registration module comprises the control unit compulsorily collecting the acceptance of a privacy commitment of the search user in respect of at least a part of the multimedia contents, and executing the advertising module comprises generating a history of the multimedia contents including at least one date of advertising for each multimedia content, saving the history of the multimedia contents to the remote server, and applying a time stamp to one or more multimedia contents uploaded on the remote server or processed by the remote server.

35. The method according to claim 34, comprising:
applying digital signatures to one or more multimedia contents.

36. The method according to claim 34, wherein executing the advertising module comprises assigning an inserting date to the multimedia contents and saving the inserting date in the remote server.
